(19) United States
(12) Patent Application Publication
(10) Pub. No.: US 2009/0039308 A1
(43) Pub. Date: Feb. 12, 2009

(54) Nanocomposite polymers

(76) Inventors: Iouri Kuzmich Gounko, County Dublin (IE); Hugh Hayden, County Louth (IE); Jonathan Nesbit Coleman, County Dublin (IE); Ian Edward O'Connor, County Kildare (IE); Werner Josef Blau, County Dublin (IE); Rowan Blake, County Wicklow (IE)

Correspondence Address: JACOBSON HOLMAN PLLC, 400 SEVENTH STREET N.W., SUITE 600, WASHINGTON, DC, 20004, US

(21) Appl. No.: 11/988,923

(22) PCT Filed: Jul. 24, 2006
(86) PCT No.: PCT/IE2006/000079

§ 371 Date: Jan. 17, 2008

(30) Foreign Application Priority Data
Jul. 22, 2005 (IE) 2005/0502

(51) Int. Cl. H01B 1/24; C08K 3/04; C08G 69/26; H01F 1/26

(52) U.S. Cl. 252/62.54; 524/496; 524/606; 252/511

(57) ABSTRACT

Modified polymers are prepared by providing a nanotube or nanoparticle suspension, adding a preformed polymer, swelling the preformed polymer in the suspension, and isolating the modified polymer from the suspension. The polymer may be a swellable polymer in the form of polymeric yarns, fibres, fabrics, ribbons or films. The swelling may be carried out using ultrasonic treatment.

The present invention relates to a method for producing modified polymer fibres.

### BACKGROUND

It has been known for many years that blending fibres, such as carbon fibres, with polymers can significantly improve the mechanical properties of the blends (1, 2, 3). GB 1179569A describes a method of reinforcing polymers by the incorporation of long fibres of material such as metal, glass or asbestos. The size of the introduced fibres are quite large.

U.S. Pat. No. 6,599,631 (WO02058928) describes inorganic particle/polymer composites that involve chemical bonding between the elements of the composite. These compositions include a polymer having side groups chemically bonded to inorganic particles. The composite composition can also include chemically bonded inorganic particles and ordered copolymers. Various electrical, optical and electro-optical devices can be formed from the composites.

It has been found that carbon nanotubules (often termed carbon nanotubes because of their diminutive dimensions) have the potential to be used in similar ways to carbon fibres. In particular, the structure of carbon nanotubes makes their aspect ratio (length/diameter, (L/D)) comparable to that of long fibres. Typically the aspect ratio of carbon nanotubes is >10000. Thus, the aspect ratio of carbon nanotubes is generally much greater than that of conventional short fibres, such as short glass fibres and short carbon fibres. In addition, the tubes can potentially be lighter than conventional carbon fibres, whilst being stronger and stiffer than the best conventional carbon fibres.

Depending on their diameter, helicity, and number of layers (single-wall versus. multiple-wall) carbon nanotubes have electronic properties ranging from those of conductors to those of semi-conductors. They may thus be added to an electrically insulating polymer to increase its conductivity. WO 97/15934 describes an electrically conductive polymer composition containing carbon nanotubes. In addition, carbon nanotubes have great mechanical stiffness, being cited as having tensile modulus in the range of 1000 GPa. Moreover they have been mentioned in connection with new, highly efficient, fracture micro-mechanisms which would prevent pure brittle failure with a concomitant low strain. Thus, carbon nanotubes have been envisaged for use in many applications in recent years (4, 5, 6, 7).

A recently reported method for processing carbon nanotubes provides nanotube fibers whose mechanical properties significantly surpass those of ordinary bucky paper (8, 9). According to this process, the carbon nanotubes are first dispersed in an aqueous or non-aqueous solvent with the aid of a surfactant. A narrow jet of this nanotube dispersion is then injected into a rotating bath of a more viscous liquid in such a way that shear forces at the point of injection cause partial aggregation and alignment of the dispersed nanotube bundles. This viscous liquid contains an agent or agents, which act to neutralize the dispersing action of the surfactant. Consequently, the jet of dispersed nanotubes is rapidly coagulated into a low-density array of entangled nanotubes, thereby gaining a small (but useful) amount of tensile strength. The wet filament is then washed in water, and the washed filament is subsequently withdrawn from the wash bath and dried. During the draw-dry process, capillary forces collapse the loosely tangled array of nanotubes into a compact thin fiber having a density of about 1.5 gm/cc (close to the theoretical density of a compact array of carbon nanotubes). This total process will henceforth be referred to as the coagulation spinning (CS) process. U.S. Pat. No. 6,682,677 (Lobovsky et al.) teach a method of forming fibers, ribbons and yarns wherein the carbon nanotubes are first dispersed in an aqueous or non-aqueous solvent with the aid of a surfactant in the coagulation spinning process described above. U.S. Pat. No. 6,764,628 (Lobovsky et al) also describes fiber spinning of two polymer compositions wherein one of the compositions contains carbon nanotubes and produces structures such as fibers, ribbons, yarns and films of carbon nanotubes. The polymers are removed and stabilization of the carbon nanotube material is achieved by post-spinning processes. The advances described enable the carbon nanotube composites to be used in actuators, supercapacitors, friction materials and in devices for electrical energy harvesting.

A modification of CS method to spin ultra-strong 100-metre-long carbon-nanotube composite fibres has also been described (10). Unfortunately, the fibres made by CS process are not useful in applications because of a surprising shape memory effect. This shape memory effect causes the CS fibres to dramatically swell (by 100% or more) and lose most of their dry-state modulus and strength. Because of this structural instability of fibres made by the CS process, they are unusable for polymer reinforcement applications. In addition, since the CS process does not enable a substantial mechanical draw, the obtained modulus of the fibres made by this process is 15 GPa or less, which is over an order of magnitude lower than that of the constituent individual nanotubes (about 640 GPa). The method is also very expensive and technically demanding and requires quite specific equipment.

Thus all technologies mentioned above have several drawbacks. Chemical modification of nanoparticles and nanotubes is very difficult, time taking and energy consuming process. The surface chemistry for nanoparticles and nanotubes is extremely complex and still poorly developed. Chemical modification of the surface for nanosized objects gives very low yields and require a complex multistep purification after the modification. This requires expensive equipment (e.g. chromatography, gel electrophoresis etc.) and highly qualified staff. Scale up for all these processes is also extremely difficult and challenging and would require a lot of time and resources.

A new cost effective method to modify properties polymers using nanomaterials would have valuable potential for a broad range of applications.

### STATEMENTS OF INVENTION

According to the invention there is provided a method for the preparation of a modified polymer comprising the steps of;
providing a nanotube or nanoparticle suspension;
adding a preformed polymer;
swelling the preformed polymer in the suspension; and
isolating the modified polymer from the suspension.

In one embodiment of the invention the modified polymer is washed with an appropriate solvent and dried.

The term appropriate solvent is taken to mean a normally non-swelling solvent or a non-swelling mixture of solvents for the polymer

The solvent may be selected from any one or more of an alcohol such as ethanol, or ether.

In one embodiment of the invention the nanotube or nanoparticle suspension comprises nanotube or nanoparticles suspended in a solvent.

The solvent may be selected from any one or more of n-methyl pyrollidone (NMP), dimethylformamide (DMF), organic amides, amines, ethers, esters, aldehydes, ketones, xylenes and other appropriate organic solvents. Other appropriate organic solvents are taken to mean a swelling solvent or a mixture of swelling solvents for the polymer.

In one embodiment of the invention the nanoparticles or nanotubes are selected from any one more of metals, non-metals, metal oxides, metal chalcogenides, metal pnictides, and ceramic materials.

In one embodiment of the invention the nanotubes are carbon nanotubes.

The nanotubes may be selected from single-walled, double-walled or multi-walled nanotubes.

In one embodiment of the invention the nanotubes are in the form of non-continuous nanotubes. Preferably the nanotubes are less than 50 nm in length, preferably less than 20 nm in length.

In one embodiment of the invention the nanotubes are approximately 10 μm (micrometers) in length.

In one embodiment of the invention the nanotubes comprise a length/diameter aspect ratio of greater than 100. Preferably the nanotubes comprise a length/diameter aspect ratio of greater than 10³, most preferably of greater than 10⁴.

In one embodiment of the invention the nanotubes or nanoparticles are introduced/intercalated into the polymer on swelling of the polymer in the nanotube suspension.

Less than 50% by weight of the nanoparticles are introduced into the polymer, preferably less than 30% by weight of the nanoparticles are introduced into the polymer, most preferably less than 20% by weight of the nanoparticles are introduced into the polymer.

In one embodiment of the invention greater than 0.1% by weight of the nanoparticles are introduced into the polymer.

In one embodiment of the invention the polymer is a swellable polymer. The polymer may be in the form of polymeric yarns, fibres, fabrics, ribbons or films.

In one embodiment of the invention the polymer comprises a fibre and/or film-forming polymer.

The polymer may be selected from any one or more of a polyolefin, polyester, polyamide or other polymeric materials. Preferably the polyolefin comprises a polymer selected from a polyethylene or a polypropylene.

In one embodiment of the invention the polymer is Kevlar™.

In one embodiment of the invention the swelling of the polymer is carried out at room temperature or under heating of from 20° C. to 200° C.

In another embodiment of the invention the swelling of the polymer is carried out by heating under reflux.

In another embodiment of the invention the swelling of the polymer is carried out under ultrasonic treatment. The ultrasonic treatment may be carried out at room temperature or under heating from 20° C. to 300° C.

The invention also provides a modified polymer whenever prepared by a method as hereinbefore described.

The polymer may be a reinforced polymer, a conductive polymer composite, a luminescent polymer composite and/or a magnetic polymer composite.

The invention further provides a reinforced polymer comprising a Young's modulus of between 2 and 1000 GPa, a strength of between 1 and 10 GPa and a toughness between 33 and 2000 J/g.

The invention also provides a reinforced polymer comprising a Young's modulus of between 2 and 500 GPa, a strength of between 1 and 10 GPa and a toughness between 33 and 2000 J/g.

The invention also provides use of a reinforced polymer prepared by a method of the invention or a polymer as hereinbefore described in the manufacture of any one or more of fishing gear, tyres, safety belts, sewing thread, protective clothing, bullet proof vests, durable man-made fibre, automotive and aircraft materials, cement paste, mortar and concrete.

The invention also provides use of a reinforced polymer prepared by a method of the invention or a polymer as hereinbefore described in high tenacity polymeric fibres, films, fabrics and filaments as a replacement for conventional reinforcing agents and additives.

The invention further provides use of conductive polymer composites produced by a method of the invention in electrical devices such as thermal sensors, low power circuit protectors, over current regulators, flexible conductive electrodes and/or flexible displays.

The invention also provides use of fluorescent polymer composites produced by a method of the invention in smart interactive textiles, sensors and/or as components for optical communications.

The invention further provides use of magnetic polymer composites produced by a method of the invention in electromagnetic interference (EMI) shielding such as shielding of medical equipment in hospitals and/or consumer electronics.

The invention further provides semiconducting and conducting polymer composites.

The invention also provides magnetic polymer composites.

The invention further provides fluorescent polymer composites.

### BRIEF DESCRIPTION OF THE DRAWINGS

The invention will be more clearly understood from the following description thereof given by way of example only, in which:—

FIG. 1 is a graph showing the sedimentation curves for 0.15 g/L solution MWNTs solution in NMP;

FIG. 2 are SEM images of the cross section for MWNTs-Kevlar composites. The top image is at a magnification of ×8K, the lower image is at a magnification of ×35K;

FIG. 3 are SEM images of Kevlar fibres before a) and after b) treatment with nanotube suspension under ultrasound;

FIG. 4 are graphs of the percentage increase of fibres against the time of sonication: a) linear fit and b) log scale;

FIG. 5 is a bar chart showing the comparison of an increase in Young's modulus for the different nanotube-Kevlar composites;

FIG. 6 is a graph showing the stress/strain curves for blank Kevlar fibre (bottom curve) and Kevlar fibre in 0.15 g/l of nanotube suspension (middle curve) and 0.30 g/l of nanotube suspension in NMP (top curve);

FIG. 7 is a graph of the change in tensile strength against nanotube concentration;

FIG. 8 is a graph of the change in tensile strength against nanotube mass uptake;

FIG. 9 are graphs of ultimate tensile strength (UTS) and toughness of polypropylene swollen with MWNTs in xylene and toluene under ultrasound;

FIG. 10 are cross sectional SEM images of polypropylene swollen in toluene with MWNTs;

FIG. 11 are conductivity graphs a) of a pure polyethylene film and b) of a polyethylene film swollen in toluene with a 4 g/L concentration of nanotubes;

FIG. 12 are confocal microscopy images of Kevlar fibres with luminescent quantum dots inside (λex.=480 nm): a) top scan image; b) total 3D scan image. The images were taken at 250×250 pixel resolution with 4096 channels;

FIG. 13 are confocal microscopy images of the cross-section of Kevlar fibre, which has been swollen with CdSe in NMP (λex.=480 nm): a) image of the perpendicular cut sample; b) image of the sample cut under 45° angle. The images were taken at 250×250 pixel resolution with 4096 channels;

FIG. 14 are cross sectional confocal microscope images of polypropylene films swollen with CdSe nanoparticles under ultrasound (λex.=480 nm): a) image of the film broken in liquid nitrogen; b) image of the film cut by scissors. The images were taken at 250×250 pixel resolution with 4096 channels;

FIG. 15 are magnetisation curves for Kevlar fibers swollen using a) Fe₃O₄ nanoparticles and b) cobalt ferrite nanoparticles.

### DETAILED DESCRIPTION OF THE INVENTION

We have found an improved method for producing reinforced polymer fibres, ribbons or films by swelling them in a nanoparticle suspension under various conditions. The method provides the ability to modify any preformed polymer fibres ribbons or films by a simple and cost effective swelling procedure. The method provides modified polymer fibres ribbons and films with improved properties. This technology have been used to fabricate new superstrong, conductive, magnetic and fluorescent polymer composites with a broad range of potential applications.

Carbon nanotubes, magnetic (Fe₃O₄) and fluorescent (CdTe) nanoparticles suspensions have been utilised to demonstrate the fabrication of new polymer composites.

The polymer used is not particularly limited as long as the polymer can be produced in the form of yarns, fibres, fabrics, ribbons or films. The polymer is preferably a polyamide, such as a Kevlar, which is not soluble in the most of common solvents, but can be easily swelled in n-methyl pyrollidone (NMP) or dimethylformamide (DMF). Multiwalled carbon nanotubes from Nanocyl can be dispersed in NMP by sonicating them for 30 min or more using an ultrasonic bath proving a good dispersion of nanotubes in the solvent. Suspensions of magnetic (Fe₃O₄) and fluorescent semiconducting (CdTe) nanoparticles can be prepared similarly. Kevlar braided yarn can be placed in the carbon nanotube or nanoparticle suspension in NMP and the mixture can be sonicated for 30 or more minutes. The solution can be then heated under reflux for up to 24 hours. Alternatively, Kevlar fibre may be left to swell in the nanotube suspension in NMP at ambient temperature for up to 24 hours or left in the suspension under ultrasound (ultrasonic bath) for up to 12 hours. The Kevlar yarn can be removed and washed in ethanol several times to remove any residual nanotubes or nanoparticles from the Kevlar surface. The Kevlar can be dried at room temperature or in oven at 100° C. Incorporation of the nanotubes during the swelling leads to a significant improvement in the mechanical properties of the blends. We have found that Young's modulus and tensile strength of Kevlar can be increased at least twofold (over 200%) by a simple swelling the Kevlar fibres in 0.3 g/L suspension of carbon nanotubes in n-methyl pyrollidone (NMP). The high increase may be achieved at the higher concentrations of carbon nanotubes. Incorporation of the nanotubes also increases electrical conductivity of polymer. Incorporation of magnetic nanoparticles results in magnetic composites, while incorporation of fluorescent semiconducting nanoparticles results in new fluorescent polymer composites.

The reinforced polymers of the invention are useful in a wide variety of applications involving the reinforcement of polymers, including for example use in fishing gear, tyres, safety belts, sewing thread, protective clothing, durable man-made fibre, and in cement paste, mortar or concrete. The reinforced polymers are particularly useful in high tenacity polymeric fibres and filaments as a replacement for conventional reinforcing agents.

The conductive polymer composites are useful in different electrical devices as thermal sensors, low power circuit protectors, over current regulators, flexible conductive electrodes and flexible displays.

Carbon nanotubes are used for reinforcement in the invention. By carbon nanotubes it is meant carbon tubes having a structure related to the structure of Buckminsterfullerene (C₆₀). Although often termed carbon nanotubes because of their diminutive dimensions, the carbon nanotubes used in the present invention need not necessarily have dimensions of the order of nanometers in size. The dimensions of the nanotubes may be much greater than this. However, it is preferred that the nanotubes are of a diameter from 1-50 nm, more preferably about 20 nm. Preferably the nanotubes are 1 μm or more in length, more preferably about 10 μm in length. Thus, it is preferred that the nanotubes are endowed with a high aspect ratio, having a length/diameter (L/D) of 100 or more, preferably 10³ or more and most preferably 10⁴ or more. Therefore, composites comprising these nanotubes should, when the nanotubes are properly aligned, have mechanical properties which behave similarly to those of composites containing continuous carbon fibres.

Increasing the aspect ratio of the nanotubes (at constant nanotube volume fraction and orientation) leads to enhanced strength and stiffness in the composite. A long aspect ratio and a greater increase in mechanical properties may be achieved by the functionalisation of the polymeric matrix as well as the nanotubes to give good covalent binding and ensure good interfacial shear strength. The concentration of nanotubes in the composites is strongly dependant on their solubility and an ability to form a stable suspension in a chosen solvent.

Use in the present invention of effectively non-continuous nanotubes (short in comparison to regular carbon fibres) rather than continuous fibres, allows access to typical processing techniques. These techniques permit high throughput production and fabrication of high quality, fibre shaped composites. Furthermore, due to their high strength and small diameter, the high aspect ratio of the nanotubes will not be decreased by typical polymer processing operations such as extrusion and injection. Thus polymer composites comprising nanotubes can provide the best of both worlds, high mechanical strength and ease of processing.

The quantity of carbon nanotubes added to a given quantity of polymer is not particularly limited. Typically less than 50% by wt of carbon nanotubes or less is added to the polymer. Preferably 30% by wt or less and more preferably 20% by wt or less of nanotubes is added. It is most preferred that 5% by wt or less of nanotubes is added. A very small quantity of nanotubes is capable of beneficially affecting the properties of a polymer. Very small quantities of nanotubes may be used, depending on the intended use of the polymer. However, for most applications it is preferred that 0.1% wt. of nanotubes or greater is added.

The present invention extends to a reinforced polymer obtainable according to the methods of the present invention. The reinforced polymer fibres of the present invention have superior mechanical properties, as has been discussed above. It is preferred that the modulus, the tensile strength and/or the toughness of fibres formed from the present reinforced Kevlar are greater by at least 50%, as compared with the equivalent properties of the same polymer not comprising carbon nanotubes after undergoing the same stretching procedure.

Any additives typically introduced into polymers may be included in the reinforced polymers of the invention, provided that the additives do not prevent the enhanced mechanical properties of the present polymers being obtained. Thus, additives such as pigments, anti-oxidants, UV-protective HALS (Hindered Amine Light Stabilisers), lubricants, anti-acid compounds, peroxides, grafting agents and nucleating agents may be included.

The fluorescent nanoparticles can include any 1′-VI types colloidal nanoparticles.

Magnetic nanoparticles can include any metal, alloy or metal oxide based magnetic nanoparticles.

The fluorescent polymer composites are useful in smart interactive textiles, sensors and as components for optical communications.

The magnetic polymer composites are useful in electromagnetic interference (EMI) shielding of medical equipment in hospitals, computers and consumer electronics.

The invention will be more clearly understood from the following description thereof given by way of examples only.

### EXAMPLES

### Modification of Carbon Nanotubes

Curly multiwalled carbon nanotubes were obtained from Nanocyl company. Yellow Kevlar 129 was supplied as a branded Yarn by Du Pont.

Amino functionalised carbon nanotubes were prepared via a Diels-Aler reaction using 1,4-diamino tetrazine (datz). The MWNTs (1.0×10⁻² g) were sonicated in ethanol (20 ml) for 15 minutes, to ensure a good dispersion. Datz (0.01 g) was added to the mixture and it was heated under reflux for up to 48 hrs. Each time the samples were washed twice with THF (10 ml) three times with ethanol (10 ml) and dried in vacuum.

### Synthesis of Kevlar Protected Acid Purified (KPAP) Nanotubes

The non-pure arc discharge nanotube material (0.2 g) was placed into a round bottom flask containing nitric (70 ml) and sulphuric (20 ml) acid. The Kevlar (0.6 g) was added and the mixture was sonicated for 30 minutes. Then it was heated under reflux for 12 hours. After that the mixture was allowed to cool to room temperature and the solution was transferred to a narrow sample holder.

The nanotubes were allowed to settle for three hours before the excess acid was decanted. The remaining solution was then slowly neutralised by the addition of NaHCO₃ in water. After the neutralisation process, the solution was allowed to settle overnight before the water was decanted off. The product was washed several times with water and dried in vacuum to give 0.5 g of KPAP nanotubes.

### Preparation of Kevlar-Nanotube Composites

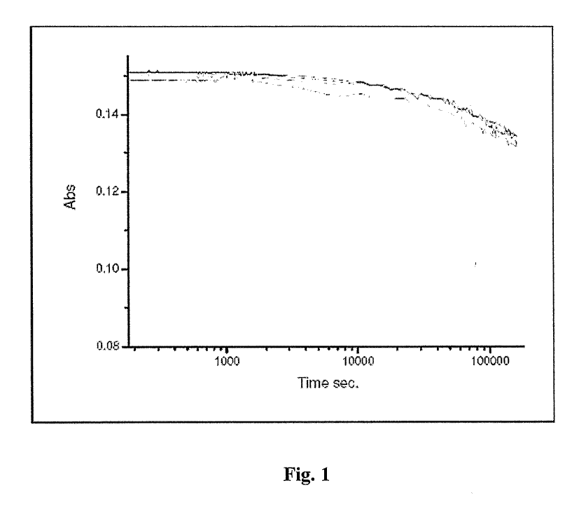

Kevlar has a very low solubility in all common solvents. It is extremely difficult to process and study this material and the nanocomposite materials by the usual methods. We have found a method for the preparation of polymer-nanotube composites, called “nano-swelling”. The process is based on the swelling of polymer (in this case Kevlar) fibres in colloidal dispersion of carbon nanotubes in NMP. Kevlar is not soluble in NMP without CaCl₂ additives, while nanotubes have a very good solubility in NMP. Sedimentation studies of 0.15 g/L solution MWNTs solution in NMP were carried out. The experiment was performed by monitoring the absorbance of the solution over time using 4 lasers. The investigation has shown that nanotubes stay in solution without any visible precipitation for at least 2 hours (FIG. 1). Then only a very small (˜6.7%) amount of nanotubes precipitated during 3 days. This allowed us to prepare a stable colloidal solution of carbon nanotubes, which then served as a medium to swell the Kevlar fibres using ultrasound and heating. Nanotubes form a stable colloidal suspension in NMP.

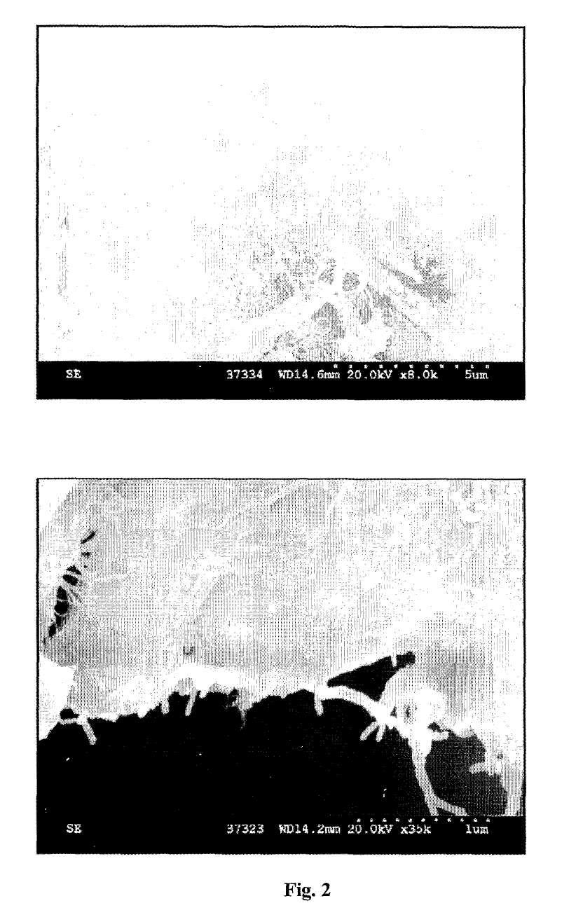

The process of the preparation of Kevlar-nanotube composite was carried out in three stages. First Kevlar fibres were cut into strips about 30 cm long and washed in acetone to remove any industrial grease/residue, the sample was then dried, and weighed. The second step was to mix the Kevlar and the nanotubes in NMP, by sonicating them for 30 minutes in the sonic bath. This was done to disperse the nanotubes and to open up the Kevlar fibre, from being tightly wound to loose fibres. The final step, the heating of the mixture under reflux for several hours, before the fibres are removed and washed by sonicating in ethanol for 1-2 minutes. The presence of nanotubes inside in Kevlar fibres have been confirmed by SEM images (FIG. 2).

The five types of nanotubes used for the preparation the nanotube-Kevlar composites are shown in Table 1 below.

TABLE 1

| Nanotube name | Description | Shape | Type of functionalisation |
|---|---|---|---|
| MWNT | Nanocyl | Curly | COOH |
| KPAP | Kevlar coated arc | Straight | COOH, NH, Kevlar |
| | discharged | | |
| SWNT | Pure | Straight | COOH |
| MWNT-datz | NH₂ functionalised | Curly | COOH, NH₂ |
| SWNT-datz | NH₂ functionalised | Curly | COOH, NH₂ |

During the preparation of Kevlar-nanotube composites, a study was carried out to see how many nanotubes became adhered to the Kevlar matrix. A series of reaction conditions using the different nanotubes, were made up in 20 ml of NMP. A pre-weighed Kevlar sample was added to each NT solutions and sonicated for 30 minutes, before being heated under reflux for up to 24 hours. The samples were then washed, dried and weighed. The concentration of nanotubes in each Kevlar sample was calculated. The highest intake of nanotubes was found to take place during the first hour of heating. Longer heating does not increase the nanotube content too much.

The process of the preparation of Kevlar-nanotube composite using ultrasound was carried out similarly above in three stages. First Kevlar fibres were cut into Im long strips and weighed. The second step was to mix the Kevlar and the nanotubes in NMP, by sonicating them for a certain period of time in the sonic bath. Many different techniques were tried to get the optimum results including different sonication times from 5 minutes up to 4 hours. Also it was tried using varying concentrations, 0.15 g/l up to 1.5 g/l. When we add the Kevlar fibres to the solution they can be swelled in the NMP. This lets the nanotubes be dispersed within the fibre of the Kevlar by a combination of swelling of the and diffusion of the nanotubes fibres in NMP. Diffusion can, in general, be characterized by an average displacement from the starting point, x, that varies in time, t, as x is proportional to (Dt)^{1/2}, where D is the diffusion coefficient. Similar to Fickian mass transport the transport of nanotubes into the porous swelled polymer by diffusion displays similar temporal behavior with a square root time dependence. In this case, the intercalated mass uptake as a function of time is given by

$$\frac{{m}_{NT}}{{m}_{p}} = {( \frac{{m}_{NT}}{{m}_{p}} )}_{sat} \sqrt{( \frac{16 D}{{b}^{2} π} ) t}$$

where,
(m_{NT}/mₚ)ₛₐₜ is the saturated value of the mass uptake,
D is the diffusion coefficient and
b is the thickness of the fibre

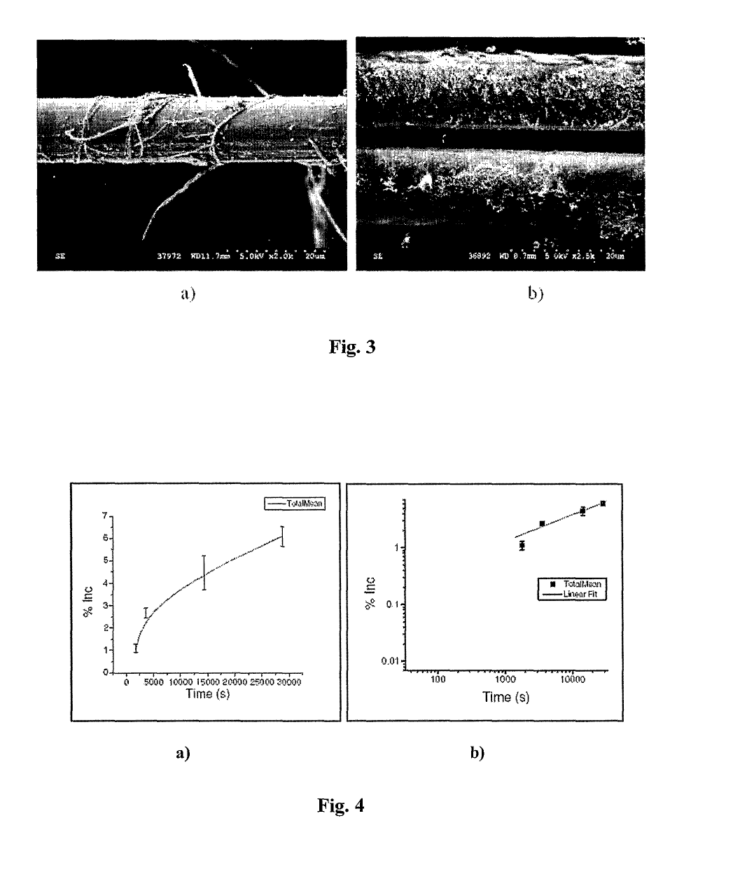

We have tried different concentrations of both thin and thick multi-walled nanotubes for different time periods. When the fibres are removed from the solvent and washed, the Kevlar fibres contract again leaving the nanotubes encased within the Kevlar fibres. There are also many nanotubes left on the surface of the Kevlar fibres as can be seen here in SEM images (FIG. 3) before and after treatment.

To determine what percentage of nanotubes are actually contained in the composite fibres some mass uptake measurements were made. The samples were weighed before treatment and following sonication treatment, washing and drying it was weighed again. Through control experiments it was found that there was considerable change (1-2%) in mass of the fibres when they were brought into contact with NMP. This was a decrease in mass that was associated with the length of time the sample was in contact with the NMP. This had to be taken into account when finding the mass uptake of the Kevlar fibres. The following graph (FIG. 4) shows the percentage increase in mass due to nanotubes (taking into account the decrease associated with NMP) against the time it was sonicated in the NMP (see also Table 2).

In FIG. 4 we can see the linear increase in a) If the increase is according to diffusion processes then the slope of the graph on a log scale should be approximately equal to 0.5. We can see this in b) and calculate the linear fit to 0.47.

TABLE 2
Nanotube mass uptakes in Kevlar composites.

| Sonification | Aver. % Increase | Aver. % Decrease in | |
|---|---|---|---|
| time (s) | Kevlar + NT | Kevlar due to NMP | Total Aver. % Inc |
| 28800 | 4.12369 +/− 0.25423 | 1.97928 +/− 0.18535 | 6.10298 +/− 0.43958 |
| 14400 | 2.90683 +/− 0.48819 | 1.57378 +/− 0.26223 | 4.48061 +/− 0.75042 |
| 3600 | 1.42937 +/− 0.12535 | 1.2534 +/− 0.09627 | 2.68276 +/− 0.22162 |
| 1800 | 0.23295 +/− 0.1008 | 0.87571 +/− 0.08826 | 1.10866 +/− 0.18907 |

### Mechanical Testing of Kevlar-Nanotube Composites

Tensile modulus and tensile strength of Kevlar-nanotube composites have been measured using Zwick 100 tensile tester or using DMTA machine. Each fibre was placed in the Zwick holder, and each end was tied. The fibre was then pulled using a 100 kN pulling detector. A measurement of the fibres strength, was plotted against force applied, and from this the tensile modulus was calculated. Each measurement was repeated 3 times and an average Young's modulus was taken.

The Kevlar samples modified with Nanocyl MWNTs showed an increase in the Young's modulus by to a factor of 2.3.

The NH₂-MWNT-Kevlar composites were found to give an increase in Young's modulus up to 2.7 times, when compared to the original Kevlar sample. These results are comparable to the Nanocyl MWNTs-Kevlar composites, but there is higher intake percentage of nanotubes for datz-MWNT-Kevlar composites.

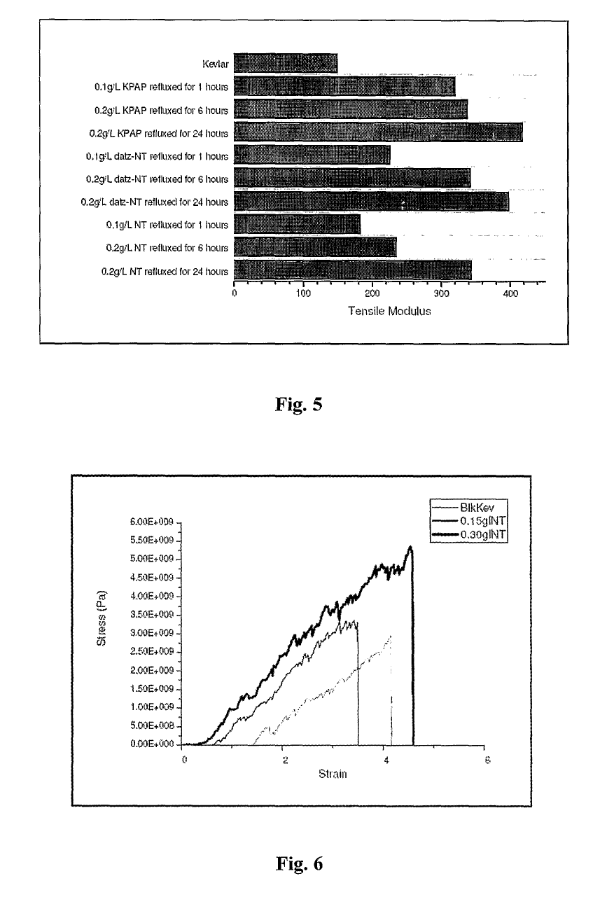

The best results were observed for Kevlar composites comprising Kevlar coated arc-discharge nanotubes. These composites demonstrated an increase in Young's modulus up to 2.8 times. It appears that the Kevlar coated arc discharge nanotubes have a stronger interaction with the Kevlar matrix providing an efficient stress transfer between Kevlar fibres and nanotubes. The results on the mechanical testing for different Kevlar-nanotube composites are shown in FIG. 5 and in Table 3 below.

TABLE 3

| | | Average (out of 3) | | % increase in |
|---|---|---|---|---|
| Type of material | Reaction conditions | Young's Modulus | Deviation | Young's modulus |
| Kevlar 129 Polymer | — | 149 | [3] | N/A |
| Kevlar + MWNT | Refluxed 1 hour | 183 | [11] | 123 |
| Kevlar + MWNT | Refluxed 6 hours | 235 | [8] | 158 |
| Kevlar + MWNT | Refluxed 24 hours | 343 | [17] | 230 |
| Kevlar + KPAP NT | Refluxed 1 hour | 320 | [12] | 214 |
| Kevlar + KPAP NT | Refluxed 6 hours | 337 | [10] | 226 |
| Kevlar + KPAP NT | Refluxed 24 hours | 417 | [7] | 280 |
| Kevlar + NH2-NT | Refluxed 1 hour | 226 | [8] | 152 |
| Kevlar + NH2-NT | Refluxed 6 hours | 342 | [13] | 230 |
| Kevlar + NH2-NT | Refluxed 24 hours | 398 | [7] | 267 |

Mechanical tests of the Kevlar-nanotube composites prepared by ultrasonication technique have been performed on the individual single micro-fibres. Each fibre is 10 microns thick. The Kevlar-nanotube composites were tested using DMTA machine. The comparative stress/strain curves for blank Kevlar fibre and Kevlar fibre in 0.15 and 0.30 grams of Nanocyl nanotubes per litre of NMP are shown FIG. 6. We have found that the tensile strength of the Kevlar-nanotube composite was raised by up to 5.3 GPa, that is significantly higher than for the original Kevlar fibre. Calculated toughness for the Kevlar-nanotube composites was more than 3 times higher than one for the original Kevlar fibre.

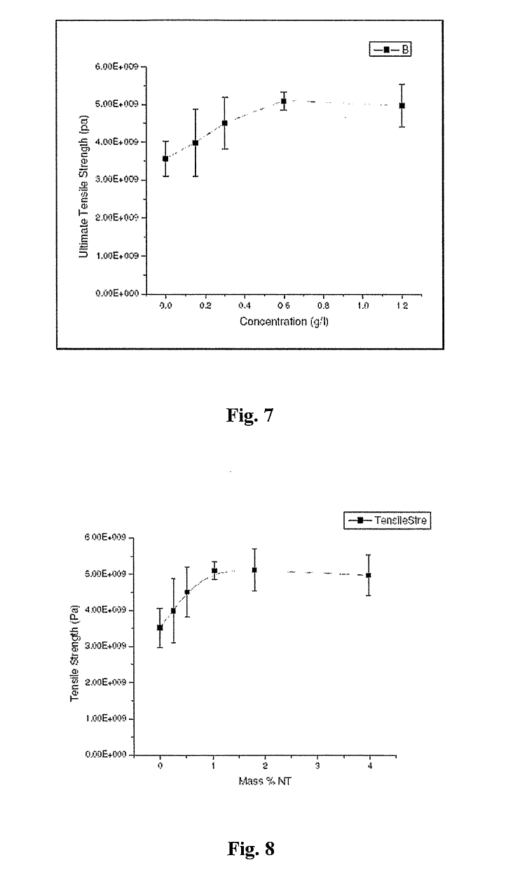

This was one particular case and although it looked promising we needed to measure a number of samples for each concentration to get a statistically accurate result. The graph in FIG. 7 shows how the tensile strength varies with changing concentration for the single fibres. Each sample was sonicated for 30 minutes. The value at 0 g/l corresponds to the untreated Kevlar (blank).

The literature value of blank Kevlar has already been shown to be 3.3 to 3.5 Gpa and this experiment agrees with this value. We can see an increase from this value to a maximum mean value of 5.1 Gpa. This shows approximately a 45% increase in the tensile strength of the single fibres.

Dependence of tensile strength of Kevlar-nanotube composites from carbon nanotube mass % uptake is shown in FIG. 8. As we can see the highest increase in strength (˜5.1 GPa) is achieved at 1 mass % of carbon nanotube uptake.

Fabrication of Polymer-Nanotube Composite Films and Investigation of their Mechanical Properties

### Mechanical Strength Tests of Xylene and Toluene Swollen Polypropylene (PP) Films

Solutions of 6 mg of nanotubes in 10 ml of toluene and xylene were prepared. 10 cm of PP was added to each of these solutions and they were sonicated using the sonic tip for 20 min. Following this they were sonicated in an ultra sonic bath for 30 min. These films were then washed in ethanol and allowed to dry. The films were then cut into strips which were then examined in a Zwick tensile tester. The results of which are shown in FIG. 9. The ultimate tensile strength, or point at which the polymer breaks and toughness increase dramatically.

### SEM Investigation of Polymer/Nanotube Swollen Films

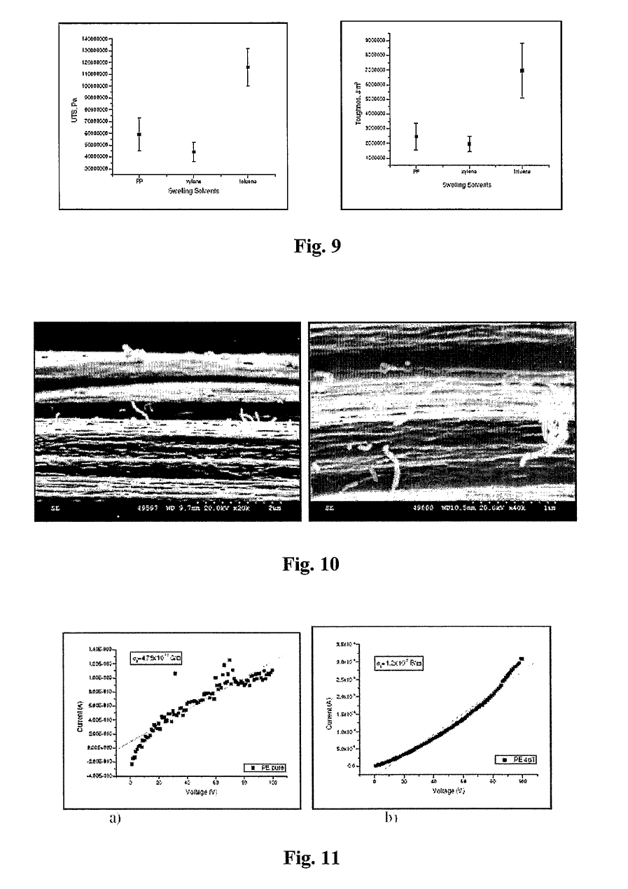

Solutions of 6 mg/10 ml of MWNTs in 20 ml of toluene and NMP were prepared. To these solutions 10 cm×2.5 cm strips of PP were added. These strips were sonicated under the sonic tip for 20 min. They were then washed in a solution of ethanol and allowed to dry. These strips were then frozen with liquid nitrogen and broken. These broken edges were then set on to disks of 1 cm diameter and coated in gold. The cross sectional SEM images of PP with carbon nanotubes are shown in FIG. 10.

Preparation of Polymer-Nanotube Composite Films and their Conductivity Studies

10 cm×2.5 cm strips of polyethylene (PE) were added to a solution of 4 g/L of MWNTs in toluene and were sonicated using the ultrasonic tip for 20 min. Then the samples were washed with ethanol and allowed to dry on the air. The results of the conductivity studies of the PE films are shown in FIG. 11. It can be seen that the conductivity of the composites increases dramatically (4 orders of magnitude to compare with the original PE films).

### Preparation of Luminescent Polymer-Nanoparticles Composites

Kevlar Fibres Swollen with Luminescent CdSe Nanoparticles in NMP

1 meter of Kevlar fibre was added to a solution of CdSe nano-particles in 20 ml of NMP. The mixture was then sonicated using the sonic tip for 30 mins at 20% tip power. The solution was then removed from the sonic tip and placed in the sonic bath where it was sonicated for another 1 hr. The Kevlar was then removed and washed in ethanol.

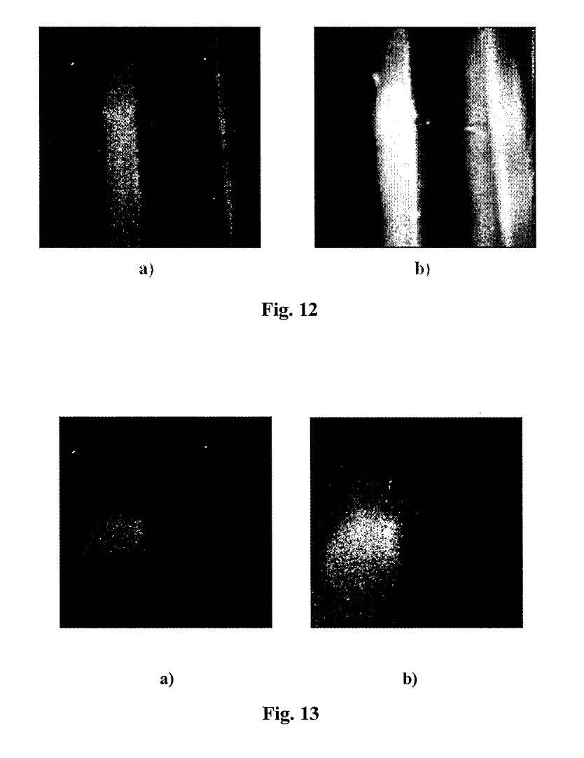

Confocal microscopy images of the luminescent Kevlar-nanoparticles composites are shown in FIG. 12. The image on the left shows a single snap shot of the quantum dots luminescing in Kevlar. The image on the right is an average of images taken at different focal points through the fibre. This image shows that the dots are luminescing through the entire Kevlar fibre. The modified fibres were then cut using a blade and the cross-section images of the samples were taken using fluorescent confocal microscope (FIG. 13). As it can be seen in the two images, a single Kevlar fibre which is cut at the end contains luminescent nanoparticles in the centre.

Polypropylene Films Swollen with Luminescent CdSe Nano-Particles in Chloroform

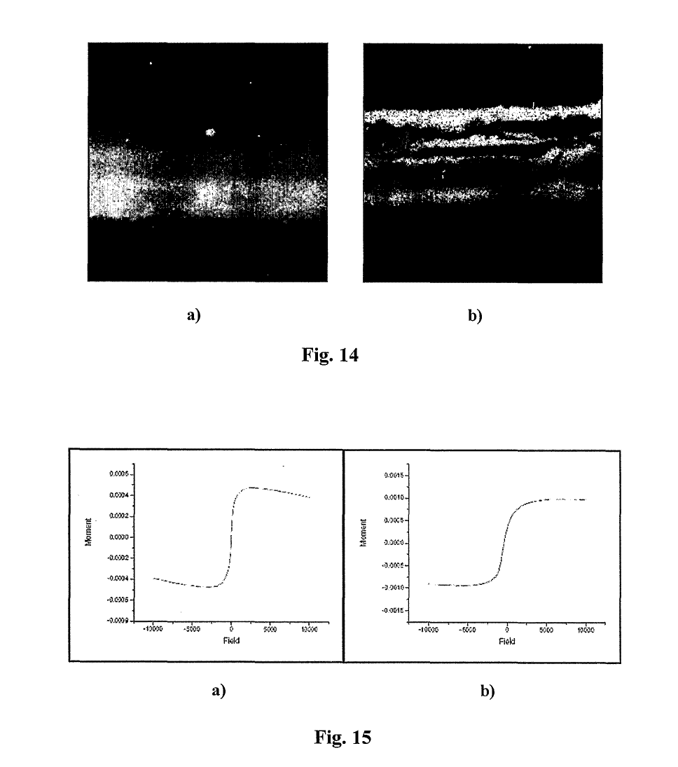

A polypropylene film was added to a solution of 100 μml in 20 ml of CdSe solution in chloroform. This was treated to 30 min under sonic tip set at 20% and 1 hr in a sonic bath. This was then washed in ethanol. The luminescent properties of the film have been studied using fluorescent confocal microscopy. The PP-nanoparticle composite film was broken in liquid nitrogen and then examined using a confocal microscope. Confocal images of the profile of PP film with CdSe nanoparticles are shown in FIG. 14. We can see the emission of CdSe nanoparticles at the cross sectional area of the PP film. It is evident from this image that fluorescent nanoparticles have penetrated through out the entire film.

### Preparation of Magnetic Kevlar-Nanoparticles Composites.

A 0.6 g/L solution of cobalt ferrite nanoparticles in 10 ml of NMP was prepared and 1 meter of Kevlar was added to the suspension. The mixture was treated to 30 min under the sonic tip followed by 1 hr in the sonic bath. The samples were then washed in ethanol. Magnetite (Fe₃O₄) nanoparticles-Kevlar composites have been prepared analogously. Magnetisation studies of the magnetic composites have been performed using SQUID magnetometer. The resulting magnetisation curves of the fibres swollen with the magnetic nano-particles are shown in FIG. 15.

### The Polymer Composites of the Invention Provide a Number of Advantages as Follows:—

a) The method of the invention is a very cost effective technique for providing modified polymers. The method is based on a simple polymer swelling in nanotubes or nanoparticles suspension. It does not require any initial chemical modification or pre-treatment of nanoparticles or nanotubes and polymer and their purification. A standard commercially available polymer in the form of yarns, fibres, fabrics, ribbons or films may be used with an appropriate organic solvent or a mixture of solvents, which are swelling solvents for the polymer. This provides a suspension for nanoparticles or nanotubes which is suitable for the swelling of the selected polymer material. Common solvents for polymer swelling are used. The method allows for all the processes to be carried out at room temperature if necessary and the method does not require the use of any expensive and sophisticated equipment.

b) The method is very universal. It may be developed for any polymeric material, which is able to swell. It may be used for different types of nanoparticles and nanotubes and can result in a very broad range of materials with a number of different potential applications.

c) The method may be easily developed for use in industry. The technique may be easily integrated into modern technologies for polymer fibre or textile modification for example it can be easily implemented using existing fibre or textile colouring techniques and equipment. Therefore the method should reach manufacturing qualification and acceptance more quickly than other alternative approaches.

The invention is not limited to the embodiments hereinbefore described which may be varied in detail.

### REFERENCES

1. Polymer Composites, April 1987, Vol. 8, No. 2, 74-81; J. Composite Materials, Vol. 3, October 1969, 732-734;
2. Polymer Engineering and Science, January 1971, Vol. 11, No. 1, 51-56.
3. M. Ahmed, “Polypropylene Fibres—Science and Technology”, Textile Science and Technology 5, High tenacity industrial yarns 389-403 and 665-681, Elsevier Amsterdam 1982.
4. P. Calvert “Potential application of nanotubes” in Carbon Nanotubes, Editor T. W. Ebbeson, 297, CRC, Boca Raton, Fla. 1997;
5. T. W. Ebbeson, “Carbon Nanotubes”, Annu. Rev. Mater. Sci., 24, 235, 1994;
6. Robert F. Service, “Super strong nanotubes show they are smart too”, Science, 281, 940, 1998;
7. B. I. Yakobson and R. E. Smalley, “Une technologie pour le troisieme millenaire: les nanotubes”, La Recherche, 307, 50, 1998.
8. B. Vigolo et al. in Science 290, 1331 (2000)
9. R. H. Baughman in Science 290, 1310 (2000).
10. A. B. Dalton S. Collins, E. Mufioz, J. M. Razal, V. H. Ebron, J. P. Ferraris, J. N. Coleman, B. G. Kim, and R. H. Baughman, Nature 423, 703 (2003)

1-42. (canceled)

43. A method for the preparation of a modified polymer comprising the steps of;
providing a nanotube or nanoparticle suspension;
adding a preformed polymer;
swelling the preformed polymer in the suspension; and
isolating the modified polymer from the suspension.

44. The method as claimed in claim 43 wherein the modified polymer is washed with an appropriate solvent or a mixture of solvents, selected from any one or more of an alcohol or ether.

45. The method as claimed in claim 43 wherein the nanotube or nanoparticle suspension comprises nanoparticles suspended in a solvent or a mixture of solvents selected from any one or more of water, n-methyl pyrollidone (NMP), organic amides (such as dimethylformamide (DMF)), amines, ethers, esters, aldehydes, ketones, and xylenes and other appropriate organic solvents.

46. The method as claimed in claim 43 wherein the nanoparticles or nanotubes are selected from any one more of metals, non-metals, metal oxides, metal chalcogenides, metal pnictides, and ceramic materials.

47. The method as claimed in claim 43 wherein the nanotubes are carbon nanotubes.

48. The method as claimed in claim 47 wherein the nanotubes are selected from single-walled, double-walled or multi-walled nanotubes.

49. The method as claimed in claim 46 wherein the nanotubes are in the form of non-continuous nanotubes.

50. The method as claimed in claim 49 wherein the nanotubes are less than 50 nm in length, such as less than 20 nm in length such as approximately 10 μm (micrometers) in length.

51. The method as claimed in claim 46 wherein the nanotubes comprise a length/diameter aspect ratio of greater than 100, such as a length/diameter ratio of greater than 10³ or a length/diameter ratio of greater than 10⁴.

52. The method as claimed in claim 43 wherein the nanotubes or nanoparticles are introduced/intercalated into the polymer on swelling of the polymer in the nanotube suspension.

53. The method as claimed in claim 52 wherein less than 50% by weight of the nanoparticles or nanotubes are introduced into the polymer, such as less than 30% by weight of the nanoparticles are introduced into the polymer; or less than 20% by weight of the nanoparticles are introduced into the polymer.

54. The method as claimed in claim 52 wherein greater than 0.1% by weight of the nanoparticles are introduced into the polymer.

55. The method as claimed in claim 43 wherein the polymer is a swellable polymer.

56. The method as claimed in claim 43 wherein the polymer is in the form of polymeric yarns, fibres, fabrics, ribbons or films.

57. The method as claimed in claim 43 wherein the polymer comprises a fibre-forming polymer and/or a film-forming polymer.

58. The method as claimed in claim 43 wherein the polymer comprises a polymer selected from any one or more of a polyolefin, a polyester, and a polyamide; the polyolefin may comprise a polymer selected from a polyethylene or a polypropylene; the polymer is Kevlar™.

59. The method as claimed in claim 43 wherein swelling of the polymer is carried out at room temperature or under heating of from 20° C. to 200° C.

60. The method as claimed in claim 43 wherein the swelling of the polymer is carried out by heating under reflux.

61. The method as claimed in claim 43 wherein the swelling of the polymer is carried out using ultrasonic treatment, such as ultrasonic treatment carried out at room temperature or under heating of 20° C. to 300° C.

62. A reinforced polymer comprising a Young's modulus of between 2 and 1000 GPa, a strength of between 1 and 10 GPa and a toughness between 33 and 2000 J/g.

63. Use of a reinforced polymer prepared by a method as claimed in claim 43 in the manufacture of any one or more of fishing gear, tyres, safety belts, sewing thread, protective clothing, bullet proof vests, durable man-made fibre, automotive and aircraft materials, cement paste, mortar and concrete.

64. Use of a reinforced polymer prepared by a method as claimed in claim 43 in high tenacity polymeric fibres, films, fabrics and filaments as a replacement for conventional reinforcing agents and additives.

65. Use of conductive polymer composites produced by a method as claimed in claim 43 in electrical devices such as thermal sensors, low power circuit protectors, over current regulators, flexible conductive electrodes and/or flexible displays.

66. Use of fluorescent polymer composites produced by a method as claimed in claim 43 in smart interactive textiles, sensors and/or as components for optical communications.

67. Use of magnetic polymer composites produced by a method as claimed in claim 43 in electromagnetic interference (EMI) shielding such as shielding of medical equipment in hospitals and/or consumer electronics.
